(19) United States
(12) Patent Application Publication
(10) Pub. No.: US 2006/0085778 A1
(43) Pub. Date: Apr. 20, 2006

(54) AUTOMATIC ADDITION OF POWER CONNECTIONS TO CHIP POWER

(75) Inventors: Joachim Keinert, Altdorf (DE); Juergen Pille, Stuttgart (DE); Christian Schweizer, Gaertringen (DE); Jens Noack, Stuttgart (DE)

Correspondence Address: INTERNATIONAL BUSINESS MACHINES CORPORATION;DEPT. 18G, BLDG. 300-482, 2070 ROUTE 52, HOPEWELL JUNCTION, NY, 12533, US

(73) Assignee: INTERNATIONAL BUSINESS MACHINES CORPORATION, Armonk, NY (US)

(21) Appl. No.: 11/163,449

(22) Filed: Oct. 19, 2005

(30) Foreign Application Priority Data
Oct. 20, 2004 (DE) 04105193.9

(51) Int. Cl. G06F 17/50; G06F 9/45

(52) U.S. Cl. 716/9; 716/10

(57) ABSTRACT

The present invention relates to a method for designing a hierarchical, multi-layer integrated circuit (IC) chip design in which a first stage design at a lower level of the hierarchical design provides details of circuit features that occupy areas of the design, and in a higher level stage of the design process corresponding to a higher level of the hierarchy, those details are used to determine free areas in the lower level design that are not yet occupied by circuit features, and allowing further processing of those free areas during the higher level design stage. For example, this may include identifying free tracks within a basic power grid layer and implementing additional power wiring within that power grid layer without having to redo the lower level design.

### BACKGROUND OF THE INVENTION

1.1. Field of the Invention

The present invention relates to the development of digital or analogue Integrated Circuits (IC). In particular, it relates to a method and system to be applied during a multi-layer, digital Integrated Circuit Chip design procedure, in which the chip design is developed in a predetermined sequence of multiple workflow design stages effective at least on either of macro level, unit level and chip level, wherein each design stage imposes design constraints for the next higher-level stage by occupying respective stage-specific chip layer areas.

1.2. Description and Disadvantages of Prior Art

Today's Integrated Circuit (IC) chip design methods are based on developer program tools, covering the whole range of the chip development in a work flow comprising a sequence of multiple development stages. Mostly, a stage takes as input the result of a preceding stage, whereby a hierarchical development workflow is introduced. Even with a so-called flat design, there are at least cells and macros to be placed at the chip level, therefore at least two levels of hierarchy exist, i.e. cell/macro and chip. This hardware hierarchy is schematically shown in FIG. 1, where a chip 10 comprises units 4 of macros 2. Macros 2 in turn may include smaller cells or books (not shown).

Usually, the chip design process consists of several design stages that relate to the hierarchy and it is usually done bottom up. On each level of hierarchy, the workflow is similar.

An example of a state-of-the-art developer's work bench is described in the brochure titled “Cadence Reference Flow for the IBM-Chartered 90 nm CMOS process streamlines design of SoCs.” disclosed at:

http://www-306.ibm.com/chips/techlib/techlib.nsf/techdocs/54EB563D93AABEC387256E9B0072745C/$file/IBM-Cadence90nmRefFlow5-21.pdf

This prior art developer's work bench includes electronic program tools, which implement the sequence of the following phases:

RTL synthesis, which creates a logic netlist;

Silicon virtual prototyping and physical synthesis, which maps to technology;

Placement of the cells and macros at higher hierarchy levels or of transistors at the lowest hierarchy level;

Routing of power, signal and clock wiring;

Physical verification Comprising Design Rule Check (DRC), Layout versus Schematic (LVS) check;

Interconnect parasitic extraction, Si closure, comprising Signal integrity and timing analysis;

Power analysis, comprising power drop and noise analysis;

At lower levels of hierarchy only the following phases are performed:

The generation of layout abstracts for next design phases.

This sequence of design phases or at least similar variations thereof are repeated in different levels of hierarchy and design stages as shown in FIG. 2, from the cell/macro stage 21 to the unit stage 22 to the chip stage 23. Disadvantageously, only a layout abstract 25 instead of all details is taken to the next design stage.

FIG. 3 is given to illustrate the process of abstraction taking place during before-mentioned chip design. On the left, the layout view of a wiring layer of macro 31 is shown. This view is transformed to a layout abstract 35 on the right side. This abstract view 35 is used in the next level of hierarchy (unit) for wiring of power, signals and clocks. As shown, detailed information about the wiring of the macro 31, which is symbolized by the plurality of different rectangles and the geometric arrangement thereof, is not available to the subsequent unit level.

In simpler words, a chip is planned in a bottom-to-top hierarchy sequence of development stages. The bottom-most stages include the use of so-called cells and books, which store information about already existing, tested, and practice-proved subcircuits, i.e., a kind of circuit library.

Elements thereof, comprising cells and books, are selected for synthesizing the chip on a macro-level.

Multiple macros are then composed to synthesize a so called unit, which implements some functional context, as e.g., an adder circuit, a storage area including read and write access circuitry, bus structures, etc.

Multiple units are then composed to represent that what is called an electronic Integrated Chip (IC), which is to be installed in a computer's motherboard for example.

In a more physical view on the chip itself, the bottom-most hierarchy level (leaf cells) built in the first development stage comprise the definition of the basic transistor layers of the chip. FIG. 4 illustrates a flow chart of prior art design phases in a comprehensive view. First, on cell or macro design stage, the cell or macro design is done including power wiring design (Block 101). Then in the unit or chip design stage 41 those cells and units are subjected to a placement procedure (Block 105).

The metallization layers above the basic transistor layers usually include metallization grids or at least grids out of a conductive material, for the supply (Block 110) of the transistors with power possibly on different voltage levels. For instance, one grid may be provided for normal chip operation (Vdd1), another one for a stand-by operation mode (Vdd2) or a power-save mode (Vdd3), and a grounded wiring grid (GND). Steps performed after the power routing (Block 110) include the signal wiring (Block 120), the clock wiring (Block 130), and diverse electrical isolation layers intersected between said layers, for example (Block 115).

Then, a plurality of further design phases denoted as xx, yy, are performed in respective Blocks 140, . . . 198, 199 with different design tools.

A major disadvantage of this prior art chip design tools is that each of the above-mentioned chip development stages is “self-contained”, i.e., detailed information is not transferred from one level to the next level of hierarchy, but only an abstracted view thereof.

FIG. 5 is a schematic zoom view into a respective prior art power supply structure of a subset of metallization layers named M3, M4, M5 of a digital Integrated Circuit chip, as it is developed according to FIG. 4.

A metallization layer M3 may be assumed to be the bottom-most layer of the drawing. It comprises an alternating series of parallel wiring of two types, the first of which is the supply voltage abbreviated with V and the second is the ground level voltage (GND), abbreviated as G in the drawing. This wiring is depicted horizontally.

Then a next metallization layer M4 located above M3 is depicted having a wiring perpendicular to the wiring in layer M3. This horizontally depicted wiring is also an alternating sequence of the pattern V-G-V-G, etc.

Then, a further metallization layer M5, again above M4, is depicted having a horizontally oriented wiring, wherein always pairs of ground voltage wirings “GG” are surrounded by a single supply voltage wiring “V,” where again the wirings “GG” and “V” are configured to be parallel to each other. Thus, in M5 a wiring pattern results in the pattern V-G-G-V, which is repeated multiply in a given chip area, of which only a zoom view is depicted in FIG. 5.

With reference to FIG. 6 the circles depicted in the drawing shall represent vias 60, which connect between layer M4 and layer M3 at cross points of wires of the same potential.

Also, the vias 61 connecting between M4 and M5 are depicted with crosses. A via thus represents a perpendicularly extending metallized connection between wiring of the same potential in different metallization layers.

With reference back to FIG. 4 and the layer structure in FIGS. 5 and 6, the following sequence of design steps is performed in prior art at the unit and chip level (Block 41):

First, some chip area is reserved for the power grid 40, which is then generated in these reserved areas (Block 110). This is true for any metallization layer. In a second design phase (Block 115) multiple vias are dropped as it was described before with reference to FIGS. 5 and 6. Then the signal wiring is designed (Block 120), to be located in some remaining chip areas on the metallization layers which areas are not yet occupied by the power grid 40.

Then, the clock wiring is designed (Block 130) in an analogous way to the signal wiring. Further, in a next phase (Block 140), verification takes place, verifying if the number of dropped vias is large enough in order to bring the supply voltage to the transistors in the basic transistor layer (not depicted in the drawings). If not sufficient, the number of dropped vias must be increased. For that step, in the prior art the design procedure does not provide the option to go back from phase 140 to phase 115, in which additional vias may be dropped. Instead, a change in the power image is necessary, i.e. redo phase 110. Alternatively, at the lower level of hierarchy, the previous design stage (Block 101) has to be redone.

Then, in a next phase 198 an additional filling of empty tracks may be performed in the prior art, in order to avoid the “dishing” effect, for example, on metallization layer M4. Such dishing effect may otherwise happen during the metal planarization using the prior art chemical-mechanical polishing (CMP production technique).

A further design phase 199 is given to illustrate further design phases which may be included, the details of which are not relevant for the actual purpose of the present invention.

As revealed from the above explanations, the design stages are “self-contained” and only abstracted views without detail information are passed to the next design stage, in the sense that they do not allow to step back, from a later into an earlier design stage without having to redo both design stages.

As a disadvantageous consequence resulting from said above-mentioned fact of “self-containment”, once a given stage has generated its specific output result, optimized according to individual technical needs, e.g., low power consumption, signal quality, speed, etc, within a given stage, this “stage-specific” result cannot be modified anymore by one of the following development tools offering one of the next higher development stages. This is a considerable obstacle for further chip design optimization.

In view of the above, there is a need to provide a chip design flow that has improved flexibility for modifying the design within a given design stage.

### SUMMARY OF THE INVENTION

It is thus an objective of the present invention to provide a

Chip design work bench for the whole chip design or at least for the design of parts of it, i.e. for the macro level or unit level or chip level, having an improved flexibility.

According to its basic aspect the present invention a method is provided for designing a hierarchical, multi-layer integrated circuit (IC) chip design having a plurality of hierarchical levels of said multi-layer IC design ordered from a lower to a higher level, wherein a lower hierarchical level comprises a subset of the next higher-level, the method comprising:

providing a first multi-layer design corresponding to a first hierarchical level, said first multi-layer design formed according to a first design stage corresponding to said first hierarchical level, wherein said first multi-layer design comprises circuit features occupying areas of said first hierarchical level, wherein said providing includes providing details of said circuit features occupying areas of layers of said first multi-layer design;

in a higher level design stage corresponding to a hierarchical level higher than said first level, determining free areas of said first multi-layer design which are not yet occupied by circuit features; and

performing further design processing of said free areas of said first multi-layer design within said higher level design stage.

The hierarchical levels may include a macro level, a unit level and a chip level.

According to another aspect of the present invention, the first design stage may comprise a plurality of design phases.

The invention may be implemented on a computer system and in a computer program product comprising instructions for causing a computer perform the method steps for design optimization according to the invention.

Further, it is to be understood by a skilled reader that before-mentioned design optimization means, which may take place according to the invention is independent of the material used therein. Thus, often an additional metallization may take place in order to improve the electrical properties of the chip due to a decreased resistance, inductance, etc. of respective electrical wiring. But also, other conductive materials may be applied for the same purpose.

### BRIEF DESCRIPTION OF THE DRAWINGS

The present invention is illustrated by way of example and is not limited by the shape of the figures of the drawings in which:

FIG. 1 is a schematic diagram representing the prior art hardware hierarchy in chip design;

FIG. 2 is a schematic diagram representing respective prior art development phases in a workflow in a chip design comprising three development stages;

FIG. 3 is a schematic diagram symbolizing the loss of detail information in a prior art workflow in chip design, when moving from one to another stage;

FIG. 4 is a schematic diagram representing details of prior art workflow in chip design;

FIG. 5 is a schematic diagram representing a partial view into prior art power supply structure of metallization layers named M3, M4, M5 of a digital Integrated Circuit chip;

FIG. 6 is a schematic diagram according to FIG. 2, including vias dropped between layer M5 and M3 (prior art);

FIG. 7 is a schematic control flow diagram, showing the essential steps of an embodiment of the invention used in a respective inventive design tool, in order to implement an inventive resume step into a preceding design phase, and applied for an additional power grid on metallization layer M4;

FIG. 8 is schematic diagram representing a partial view into a power supply structure, signal wiring and power fill in a layer M4 of a digital Integrated Circuit chip;

FIG. 9 is a schematic diagram according to FIG. 8, representing the inventive feature of adding a fill pattern of power lines after the rest of the chip design procedure was per se completed;

FIG. 10 is a schematic diagram including the vias according to FIG. 3;

FIG. 11 is a schematic diagram showing details of a channel based power wiring fill in a single metallization layer; and

FIG. 12 is a schematic diagram showing details of cutting back or extending “antennae like wiring applied on borders of a unit or a macro.

### DETAILED DESCRIPTION OF THE PREFERRED EMBODIMENT

The following definitions are given in order to provide for technical clearness of the present disclosure:

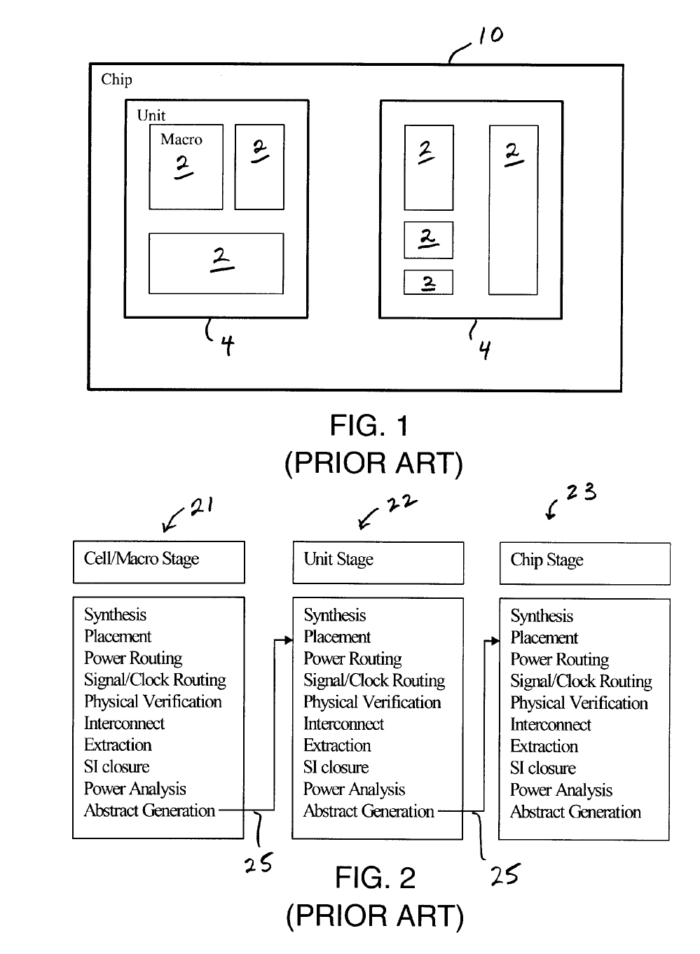

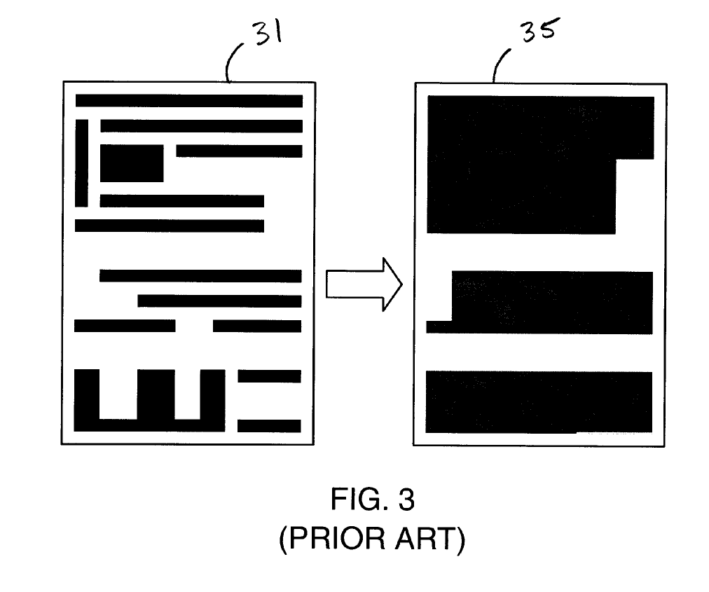

A “level” means some item of a hardware hierarchy, for example, see FIG. 1, illustrating three distinct levels: macro, unit and chip.

A “stage” is a portion of the design procedure associated with a particular hardware hierarchy.

A “phase” is in relation to “stage” a more granular section of the design procedure, e.g., the “power routing”, or “signal routing” in relation to the total design of a macro. Both are time-defined sequences of design work.

A “layer” is a space-defined term specifying a single-thickness coating constituting one of a plurality of chip layers.

A “track” is an area on the chip that can be used for power or signal wiring. A track has a defined width or span and may typically extend in either a vertical or horizontal direction.

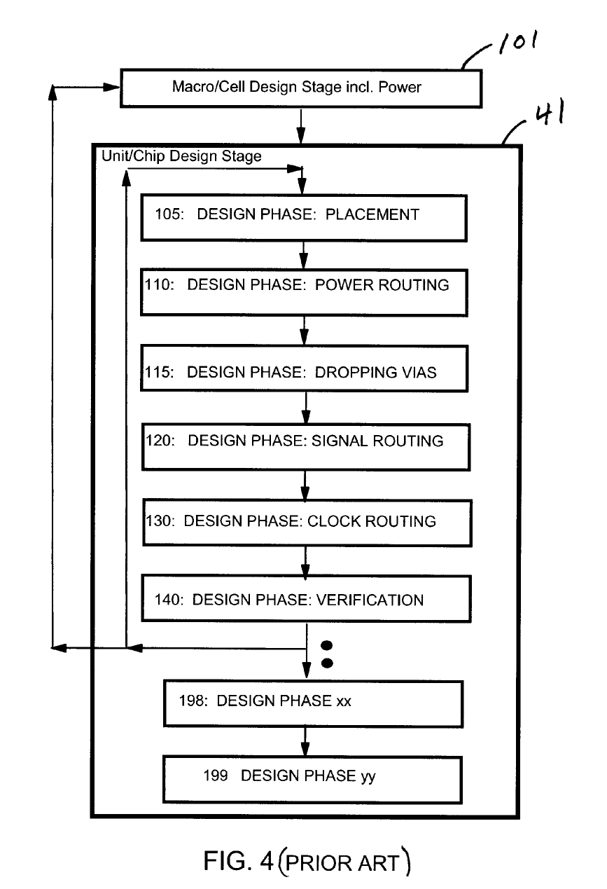

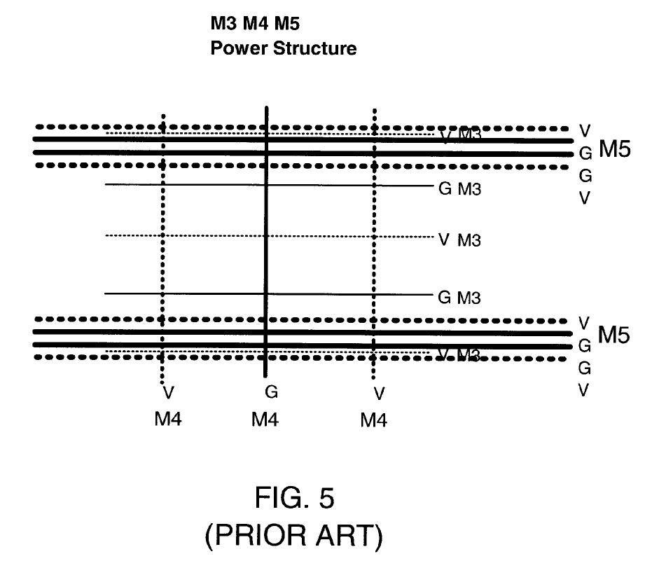

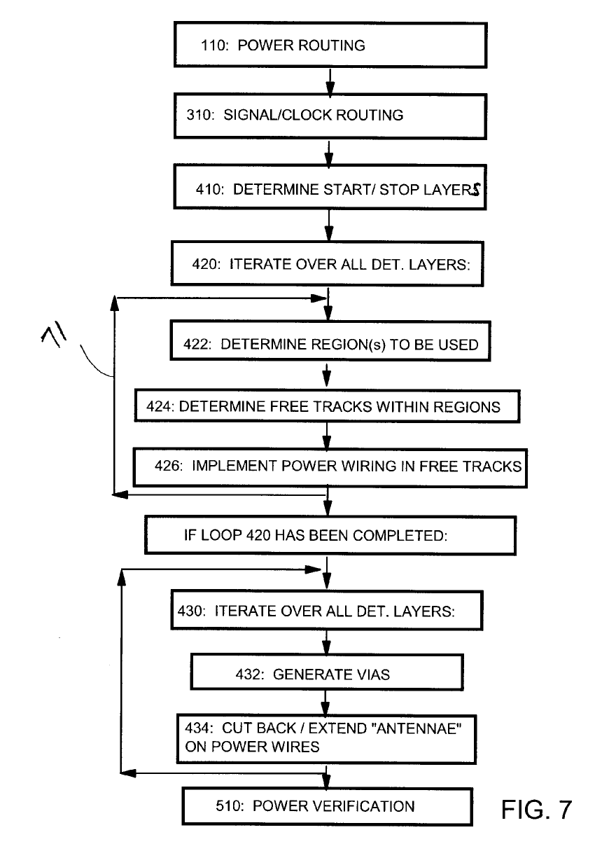

With general reference to the figures and with special reference now to FIG. 7 an exemplary embodiment of the present invention is disclosed which can be used according to the above-mentioned principles in addition or instead of the sequence of steps described along with FIG. 4, in order to improve the computer-aided design of chips, macros, regions of chips or macros, further for all metallization and via layers, or a subset of such layers, further for Ground (GND), primary supply (VDD) and other power voltages, or a subset of these power grids. Basically, this algorithm may be applied for such semiconductor designs with several layers of metal, with or without alternating wiring directions of the metal layers, be that horizontal and vertical or a combination thereof including or not including diagonal wiring directions.

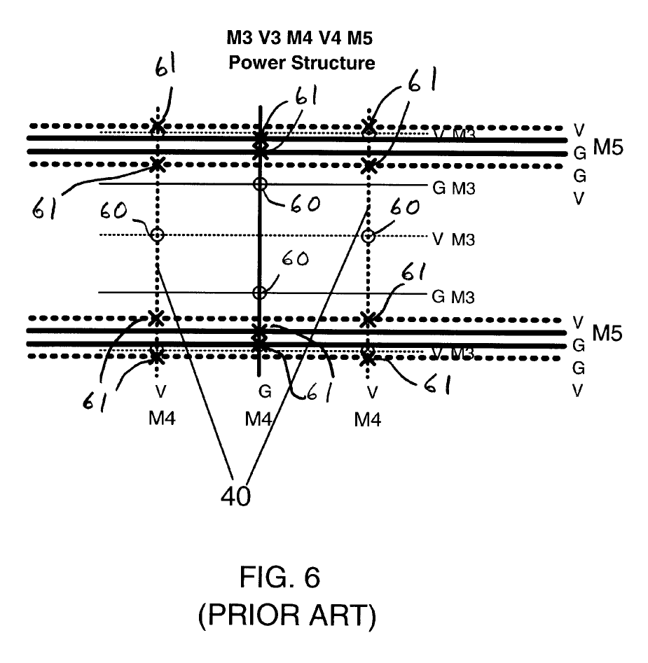

After power routing in a phase 110, resulting in a basic power grid 40 (see FIG. 6), and after signal/clock routing in a phase 310 have been laid out, the method according to the present invention begins.

In a first step 410 of the preferred algorithm the start and stop layer for the inventional algorithm is determined. For example the start layer may be M3 and the stop layer may be M5.

In a second step the iteration 420 takes place over the predetermined layers (step 410) from bottom to top or vice versa. This iteration includes the steps or block of steps 422, 424, 426. Details of these steps are given next below.

In a first step 422 the start position and end position of the region and the maximum track span is determined, in which the inventive method shall be applied. For example for a vertical wire the x-coordinates for start and stop and the y-co-ordinates for the track span is defined. Further, there may be defined more than only one area within one and the same layer which are subjected to the inventive procedure.

Then, in a next block of steps 424 the free tracks are determined, which are present within the areas determined in step 422 above.

In order to do that there are basically two alternatives: in a first alternative the geometrical area difference is determined by comparing the “bounding box” or boxes determined in step 422 above and subtracting the existing wiring (including the respective metal and via spacing). In a second alternative the free tracks may be obtained or looked up from the power and signal or clock router within the used design tool.

In a step 426 the additional power wiring is implemented in either of two alternatives:

First alternative: A predetermined power pattern like “GGG VVV GGG VVV” is laid over the bounding box and intersected with the free tracks on the same layer just as described before and giving the power tracks for this layer. The wiring pattern and the wiring width, as well as the distance (or pitch) is freely choosable. It should be clear to those skilled in the art that different patterns will be yield different power track efficiency depending on a respective design.

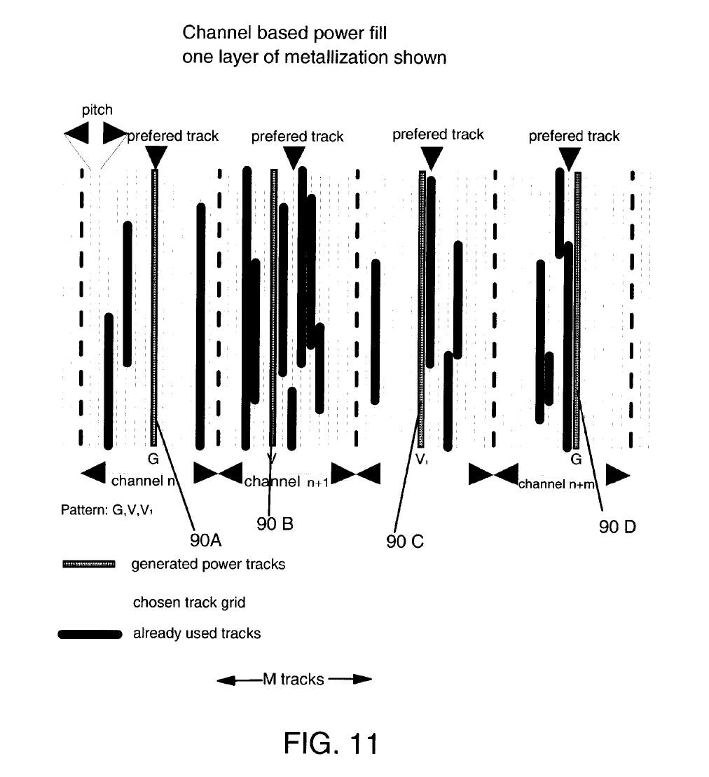

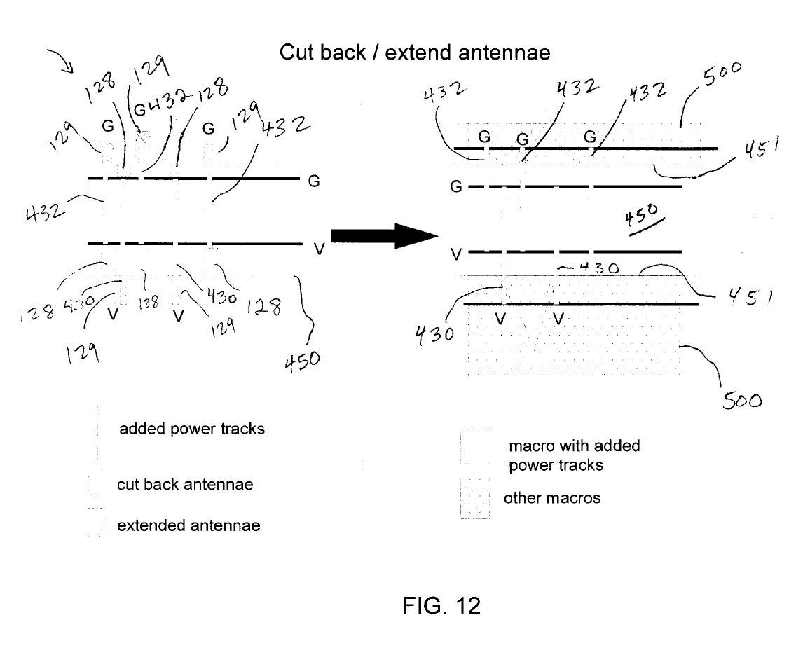

In a second alternative illustrated with reference to FIG. 11 a so-called “channel-based” grid is overlaid over free tracks, as identified by the present invention.

A channel is hereby understood to be a number of M wiring tracks wide, wherein M is a multiple of the track width, e.g. 8<M<100. Wire width and wire pitch are choosable, as described above. Then a channel pattern as defined above, or a different one, like “GVGV” or any other power net name can be used. Then a loop over all channels takes place including a first step, in which the net is selected from the channel pattern, followed by a second step, in which a free track in the current channel is searched and found. The search starts at a definable preferred point (for example left most, right most, mid most, random). The first free track closest to that point within a channel is selected for power fill.

In FIG. 11, in channel n (most left channel) the preferred track 90A is identical to the generated track 90A. In channel n+1 said preferred track 90B is found first on the left half of the channel.

In the next channel the algorithm starts in the middle of the channel (see preferred track) and finds the next free track a small step left thereof. Thus, the next power fill would be generated at position 90C. In the rightmost channel, the algorithms starts in the rightward direction and finds track 90D free and ready for power fill.

One or more wires up to a complete fill may be laid by this step. The target amount of wires in a channel and the channel width are choosable, and may be driven by the required metal density for the CMP process or the required metal porosity for additional signal/clock wiring tracks at the next hierarchy level.

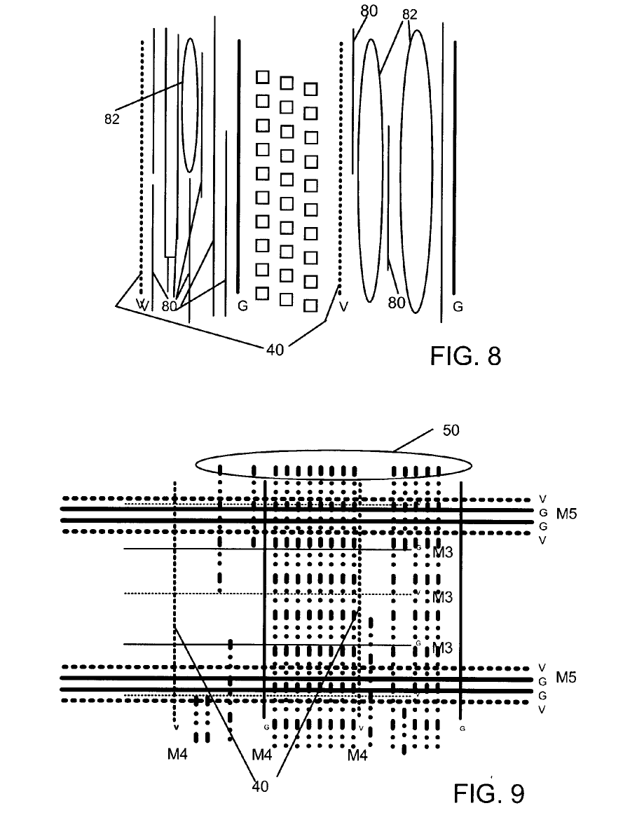

The result of the additional power wiring 50 can also be seen in FIG. 9 in context with FIG. 8, by inspecting the vertical broken-dotted lines (pattern -..-..-..), in FIG. 9, as it is indicated by a circle including the start points of said additional wiring 50. It should be noted that the additional wiring 50 is limited to free tracks in—white chip—areas 82, which are not yet filled—be that by signal wiring 80 or pre-existing “basic” power wiring 40, or by GND wiring shown in FIG. 8, or other wiring, for instance clock wiring, which is not shown in FIG. 8.

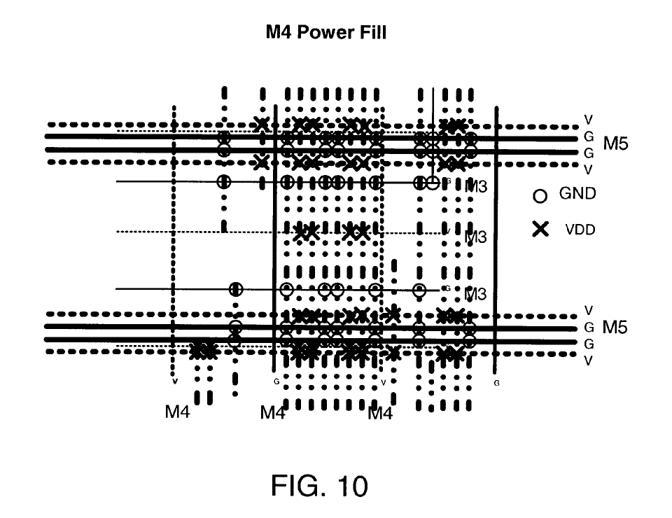

FIG. 10 additionally shows the additional vias, indicated by circles and crosses, dropped advantageously due to the inventive method.

With reference back again to FIG. 7, as a person skilled in the art may appreciate, the loop-body 71 from steps 422 to 426 is repeatedly run.

Then, in a block of steps 430 the iteration over all layers takes place from bottom to top or vice versa including a step 432 and an optional step 434.

In step 432 the vias are dropped at the respective metal crossings between the added grids of the same voltage level on different layers. For example a ground via is laid, if a freshly laid ground track on a layer Mx crosses any ground track on a layer Mx−1, i.e. the metal layer just below. The same is true of course for VDD vias and intermediate power levels (iteration bottom-to-top or vice versa).

In a second alternative a ground via is dropped if the freshly laid ground track on a layer Mx crosses any ground metal at the layer just above (Mx+1). Again, the same is true for other voltage levels grids.

Optionally, and with additional reference to FIG. 12, in a step 434 the so-called “Antennae” on power wires 430 or GND wires 432 are either cut back—see the “cutback” areas 128 in FIG. 12, or extended, see the extension areas 129, both on the left side of the drawing, in order to serve as a connection between two macros 500, or units 500, respectively, if the area 450 just subjected to the inventive method shall be duplicated and put together at a common margin line 451, which is depicted on the right side of the drawing.

The results from running the method above are then verified through power analysis (power drop, noise) in Block 510.

The present invention can be realized in hardware, software, or a combination of hardware and software. A chip design tool according to the present invention can be realized in a centralized fashion in one computer system or in a distributed fashion where different elements are spread across several interconnected computer systems. Any kind of computer system or other apparatus adapted for carrying out the methods described herein is suited. A typical combination of hardware and software could be a general purpose computer system with a computer program that, when being loaded and executed, controls the computer system such that it carries out the methods described herein.

The present invention can also be embedded in a computer program product, which comprises all the features enabling the implementation of the methods described herein, and which—when loaded in a computer system—is able to carry out these methods.

Computer program means or computer program in the present context mean any expression, in any language, code or notation, of a set of instructions intended to cause a system having an information processing capability to perform a particular function either directly or after either or both of the following

a) conversion to another language, code or notation;

b) reproduction in a different material form.

The present invention provides the advantage that free space may be used for electrical and chip fabrication yield optimization purposes.

In accordance with the invention, the additional processing is preferably an additional application of some conductive material in these free layer areas, in order to improve the electrical qualities of the chip. In most cases this will be an additional metallization step, wherein free tracks are filled with a metal. Also, other conductive materials are applicable for this purpose, for example conductive polymers.

A further type of reprocessing can be achieved as follows: When using a negative mask, metallization may be also removed from a previous design stage's hierarchy level. For example to achieve a lower target metal density or to open free space for additional signal/clock wiring tracks at the next hierarchy level.

Further, the reprocessing may also include steps, which are per se known in prior art, directed to other improvements, e.g., for increasing the form stability of a layer during a later CMP process.

By this general approach, the fixed design hierarchy is effectively dissolved in order to do additions to the wiring of a lower level, after having completed the design on a higher level. Thus, a kind of “late” resume step is introduced by the invention, which is based on the fact that detailed information from a preceding design phase is made available in a current phase.

This basic approach can be done in a single tool specialized to the design of macros, or in a tool dedicated for the design of units, or in an integrated developer's working bench offering a respective integrated solution, i.e. at various design stages and phases at various levels of hierarchy.

While the detailed data from a previous design stage remains in that hierarchy level, the additions and removals to the metallization and via layers are put into the current design stage's hierarchy level.

Further, a particular application of the general approach is to add an additional power grid or power wiring to the “traditionally” provided power grid in a more or less area-filling form, e.g., rectangle-, L-, form, or any other more complicated geometry, after having accomplished the chip design at a respective higher level, for example after completion on the chip level, or unit level. This can be done, as enough free space remains in most cases (“white space”) within the power grid layer. By that the power distribution is remarkably improved, the power noise is reduced, a higher fabrication yield is achieved and a deeper sorting of the fabricated chips, thus differentiating between different quality levels (speed, signal quality, etc.) is made available.

Such additional grid can also be added at various different voltage levels, e.g., GND-, or intermediate power levels, in order to provide a good power supply also for lower power levels in stand-by mode, sleep mode etc.

Further, assuming a “grid” to be a basically meshless arrangement of more or less parallel wiring structure on a particular layer, this method can also be applied to any meshed wiring, i.e. comprising a considerable number of closed loops within its geometrical structure, for example, spanning more than one layer. Thus, for instance a clock grid can also be implemented according to the same principle.

Further, it is to be understood by a skilled reader that before-mentioned design optimization means, which may take place according to the invention is independent of the material used therein. Thus, often an additional metallization may take place in order to improve the electrical properties of the chip due to a decreased resistance, inductance, etc. of respective electrical wiring. But also, other conductive materials may be applied for the same purpose.

While the present invention has been particularly shown and described with respect to preferred embodiments thereof, it will be understood by those skilled in the art that the foregoing and other changes in forms and details may be made without departing from the spirit and scope of the present invention. It is therefore intended that the present invention not be limited to the exact forms and details described and illustrated, but fall within the scope of the appended claims.

What is claimed is:

1. A method for designing a hierarchical, multi-layer integrated circuit (IC) chip design having a plurality of hierarchical levels of said multi-layer IC design ordered from a lower to a higher level, wherein a lower hierarchical level comprises a subset of the next higher-level, the method comprising:
providing a first multi-layer design corresponding to a first hierarchical level, said first multi-layer design formed according to a first design stage corresponding to said first hierarchical level, wherein said first multi-layer design comprises circuit features occupying areas of said first hierarchical level, wherein said providing includes providing details of said circuit features occupying areas of layers of said first multi-layer design;
in a higher level design stage corresponding to a hierarchical level higher than said first level, determining free areas of said first multi-layer design which are not yet occupied by circuit features; and
performing further design processing of said free areas of said first multi-layer design within said higher level design stage.

2. The method according to claim 1, wherein said hierarchical levels comprise a macro level, a unit level and a chip level.

3. The method according to claim 1, wherein said first design stage comprises a plurality of design phases.

4. The method according to claim 1, wherein said determining free areas comprises determining free tracks of said first multi-layer design.

5. The method according to claim 4, wherein said performing further design processing comprises implementing additional power wiring in said free tracks of said first multi-layer design.

6. The method according to claim 1, wherein said performing further design processing includes the provision of an additional metallization within said free areas.

7. The method according to claim 3, wherein said providing details comprises providing details for at least one of said plurality of design phases.

8. The method according to claim 3, wherein said plurality of design phases comprises a phase for implementing a basic form of a power grid of power wiring in a power grid layer for supplying the electrical circuits with electrical power, and one or more subsequent phases for signal wiring and clock wiring, and said performing further design processing comprises implementing an additional power wiring within said power grid layer.

9. The method according to claim 1, wherein said higher level design stage further comprises the steps of:
determining start and stop layers of said first multi-layer design for said determining free areas;
for each of said start and stop layers, determining an active layer region, determining free tracks, and overlaying an additional wiring pattern within said active layer region; and
for at least one of said multi-layers, dropping vias at one or more metal crossings defined in the projective view over multiple layers by the intersection of a grid inserted in said at least one of said multi-layers with a respective electrically equivalent grid on an adjacent one of said multi-layers.

10. The method according to claim 9, wherein the additional power wiring is implemented for supplying the chip with its primary supply voltage.

11. The method according to claim 9, wherein the additional power wiring is implemented for supplying the chip with a secondary supply voltage.

12. The method according to claim 9, wherein the additional power wiring is implemented for supplying the chip with an additional ground level grid.

13. The method according to claim 9, wherein the additional power wiring is implemented for supplying the chip with an additional clock signal grid.

14. A computer program product comprising a computer usable medium having a computer readable program for designing a hierarchical, multi-layer integrated circuit (IC) chip design having a plurality of hierarchical levels of said multi-layer IC design ordered from a lower to a higher level, wherein a lower hierarchical level comprises a subset of the next higher-level, said computer readable program embodied in said medium, wherein the computer readable program when executed on a computer causes the computer to perform the steps of:
providing a first multi-layer design corresponding to a first hierarchical level, said first multi-layer design formed according to a first design stage corresponding to said first hierarchical level, wherein said first multi-layer design comprises circuit features occupying areas of said first hierarchical level, wherein said providing includes providing details of said circuit features occupying areas of layers of said first multi-layer design;
in a higher level design stage corresponding to a hierarchical level higher than said first level, determining free areas of said first multi-layer design which are not yet occupied by circuit features; and
performing further design processing of said free areas of said first multi-layer design within said higher level design stage.

15. The computer program product of claim 15, wherein said hierarchical levels comprise a macro level, a unit level and a chip level.

16. The computer program product of claim 15, wherein said first design stage comprises a plurality of design phases.

17. The method according to claim 15, wherein said determining free areas comprises determining free tracks of said first multi-layer design.

18. The method according to claim 18, wherein said performing further design processing comprises implementing additional power wiring in said free tracks of said first multi-layer design.

19. The method according to claim 15, wherein said performing further design processing includes the provision of an additional metallization within said free areas.

20. The method according to claim 17, wherein said providing details comprises providing details for at least one of said plurality of design phases.

21. The method according to claim 17, wherein said plurality of design phases comprises a phase for implementing a basic form of a power grid of power wiring in a power grid layer for supplying the electrical circuits with electrical power, and one or more subsequent phases for signal wiring and clock wiring, and said performing further design processing comprises implementing an additional power wiring within said power grid layer.

22. The method according to claim 15, wherein said higher level design stage further comprises the steps of:
determining start and stop layers of said first multi-layer design for said determining free areas;
for each of said start and stop layers, determining an active layer region, determining free tracks, and overlaying an additional wiring pattern within said active layer region; and
for at least one of said multi-layers, dropping vias at one or more metal crossings defined in the projective view over multiple layers by the intersection of a grid inserted in said at least one of said multi-layers with a respective electrically equivalent grid on an adjacent one of said multi-layers.
